(19) United States
(12) Patent Application Publication
(10) Pub. No.: US 2023/0358287 A1
(43) Pub. Date: Nov. 9, 2023

(54) BRAKING SENSOR SYSTEM AND METHOD OF USE

(71) Applicants: SCOTT BONCHA, Nokomis, FL (US); James K. Skully, Willoughby, OH (US)

(72) Inventors: SCOTT BONCHA, Nokomis, FL (US); James K. Skully, Willoughby, OH (US)

(73) Assignees: Jame K. Skully, Willougby, OH (US); Scott Boncha, Nokomis, FL (US)

(21) Appl. No.: 18/080,368

(22) Filed: Dec. 13, 2022

Related U.S. Application Data
(60) Provisional application No. 63/288,729, filed on Dec. 13, 2021.

(51) Int. Cl. F16D 66/00

(52) U.S. Cl. CPC F16D 66/00; F16D 2066/001

(57) ABSTRACT

A braking sensor system and method of use is provided. The braking sensor system includes a plurality of temperature sensors configured to measure the temperature of each of a plurality of brakes, wherein each sensor has a corresponding wire, the wire having first and second ends, the first end of the wire being coupled to one of the plurality of sensors, the second end being coupled to an electronic control unit having a processor and memory, the electronic control unit being coupled to a visual display, wherein the temperature sensors send signals to the processor when the temperature of any one of the plurality of brakes meets a set temperature threshold range, wherein the display provides a visible alert responsive to one of the plurality of brakes meeting the temperature threshold range.

### CROSS REFERENCES TO RELATED APPLICATIONS

The following application claims priority under 35 U.S.C. § 119 (e) to U.S. Provisional Patent Application Ser. No. 63/288,729 filed Dec. 13, 2021 entitled BRAKING SENSOR SYSTEM AND METHOD OF USE. The above-identified application is incorporated herein by reference in its entirety for all purposes.

### TECHNICAL FIELD

The present disclosure generally relates to a braking sensor system and method of use, and more particularly to a braking sensor system that provides temperature readings to an operator and triggers a notification when brake temperature meets a set threshold.

### BACKGROUND

After long periods of use and/or aggressive driving, land vehicles and automobile brakes run the risk of overheating. The generation of excessive friction may cause brakes to feel soft, emit a squealing noise, and/or emit smoke and a distinct smell. When overheating occurs, the operator of the automobile or land vehicle is in danger of partial or complete loss of braking ability. In a situation where the operator is driving a vehicle responsible for the transport of goods such as a truck coupled to a trailer, this can pose heightened danger to the user and surrounding vehicles. Furthermore, if some brakes are functioning properly and others are not due to brake wear and tear, an uneven brake response is created. It would be advantageous to a vehicle operator to know when brakes were soon to overheat before the overheating actually occurred, and to know which brakes were the source of the overheating.

At approximately 450 degrees Fahrenheit, vehicle brakes are beginning to overheat. At approximately 600 degrees Fahrenheit, the brakes will begin to emit an odor noticeable by the vehicle operator. Between approximately 800- and 900-degrees Fahrenheit, smoke will be released and is visible to the vehicle operator.

### SUMMARY

One aspect of the present disclosure includes a brake monitoring apparatus for a vehicle having a plurality of temperature sensors configured to measure the temperature of each of a plurality of brakes located on a vehicle during use, wherein each sensor has a corresponding wire, the wire having first and second ends, the first end of the wire for communicative coupling to one of the plurality of temperature sensors, the second end being communicatively coupled to an electronic unit, the electronic control unit comprising a processor and memory, the electronic control unit being communicatively coupled to a visual display, wherein the plurality of temperature sensors send power signals to the electronic control unit which converts and sends temperature values of any one of the plurality of brakes for viewing during operation on a display; further wherein said plurality of temperature sensors send power signals to said electronic control unit where said electronic control unit converts said power signals with said processor or an application specific analog circuit to a respective temperature value for each brake, yet further wherein each temperature value for each brake is compared in the electronic control unit comprising a database with a selective threshold temperature assigned to each brake so that when one or more temperature values exceed said threshold temperature, a notice is transmitted to said display indicating the brake and that the temperature threshold that has been exceeded.

Another aspect of the present disclosure includes a method of temperature monitoring for a brake system having the steps of assigning a temperature range as a target temperature range on a brake monitoring system. The brake monitoring system has a plurality of brakes, and a plurality of temperature sensors configured to measure the temperature of each of the plurality of brakes. Each sensor has a corresponding wire with first and second ends, the first end of the wire being coupled to one of the sensor, and the second end being coupled to an electronic control unit having a processor and memory. The electronic control unit is coupled to a visual display. Responsive to receiving a temperature sensor input to the brake monitoring system, the brake system identifies the temperature sensor input as a received temperature based upon the temperature sensor input and matches the received temperature to the target temperature range. Responsive to matching the target temperature range to the received temperature, the brake system generates a first signal, and responsive to exceeding the target temperature range to the received temperature, the brake system generates a second signal.

Yet another example embodiment of the present disclosure includes a brake monitoring system for a vehicle having a plurality of brakes; a vehicle electronic control unit comprising a processor having memory; a vehicle visual display; and a plurality of thermocouples configured to measure the temperature of each of the plurality of brakes, wherein each thermocouple comprises a wire having first and second ends, the first end of the thermocouple wire being communicatively coupled to one of the plurality of brakes on an embedding surface of said brakes, the second end communicatively coupled to said vehicle electronic control unit, wherein each thermocouple receives a measured temperature of a corresponding one of said plurality of brakes and transmits said measured temperature through the thermocouple to the vehicle electronic control unit, wherein the electronic control unit allows for a selectively programmable temperature threshold for the received temperature from any one of the plurality of brakes and plurality of thermocouples, wherein the truck electronic control unit communicates said measured temperature to the vehicle visual display, and wherein a notification is transmitted from said vehicle visual display and wherein said notification is triggered when said measured temperature is at or above the selectively programmed threshold.

### BRIEF DESCRIPTION OF THE DRAWINGS

The foregoing and other features and advantages of the present disclosure will become apparent to one skilled in the art to which the present invention relates upon consideration of the following description of the invention with reference to the accompanying drawings, wherein like reference numerals refer to like parts unless described otherwise throughout the drawings and in which:

FIG. 1 is a schematic diagram of a land vehicle depicting the coupling between the sensors and the communication boxes in accordance with one example embodiment of the present disclosure.

FIG. 2 is a disk brake coupled to a braking sensor in accordance with one example embodiment of the present disclosure;

FIG. 3 is a hydraulic and/or mechanical drum brake coupled to a braking sensor in accordance with one example embodiment of the present disclosure;

FIG. 4 is an air brake coupled to a braking sensor in accordance with one example embodiment of the present disclosure;

FIGS. 5A-5D are a schematic diagram depicting wiring between a braking sensor system and a land vehicle in accordance with one example embodiment of the present disclosure;

FIGS. 6A-6C are a schematic diagram depicting wiring between a braking sensor system and a land vehicle such as a trailer in accordance with another example embodiment of the present disclosure;

FIG. 7 shows two electrical enclosures according to two example embodiments of the present disclosure;

FIG. 8 shows an exploded view of a mounting of a braking sensor system with a drum brake in accordance with one example embodiment of the present disclosure;

FIG. 9 shows mounting of a braking sensor system with a disk brake in accordance with one example embodiment of the present disclosure; and

FIG. 10 is a schematic diagram illustrating a method of operating a brake sensor system in accordance with one example embodiment of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Referring now to the figures generally wherein like numbered features shown therein refer to like elements throughout unless otherwise noted. The present disclosure relates to a braking sensor system and method of use, and more particularly to a braking sensor system that provides temperature readings to an operator and triggers a notification when brake temperature meets a set threshold.

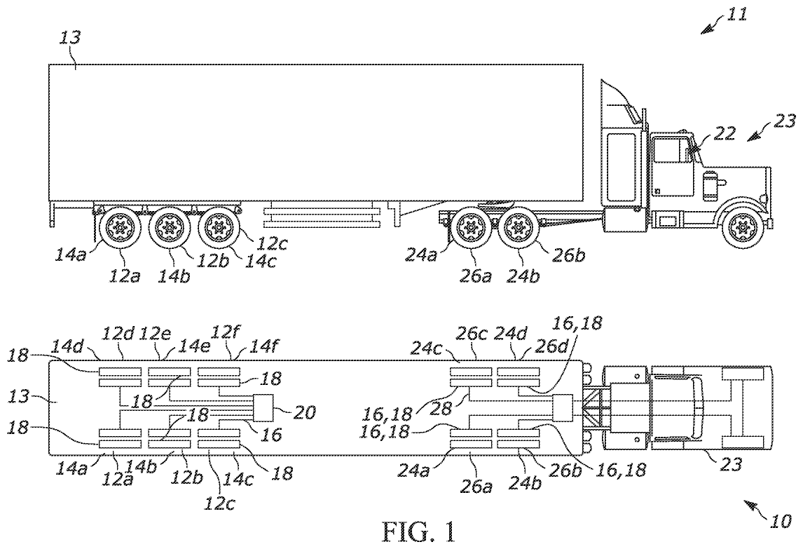

FIG. 1 illustrates a braking system 10 in accordance with one example embodiment of the present disclosure. FIG. 1 depicts the braking system 10 being used in connection with a tractor trailer, but it also may be used with larger or smaller trucks and corresponding trailers comprising different numbers of axles and may also be used to monitor trailer bearings on such trailers. The system may also be used in connection with RVs and motorized mobile homes. All of the aforementioned trucks, trailers, recreational vehicles and the like, independent of size and number of axles, will be referred hereafter be encompassed as “vehicles” unless stated otherwise. The system is also compatible with different kinds of brakes including, but not limited to, disk brakes, drum brakes, and/or air brakes.

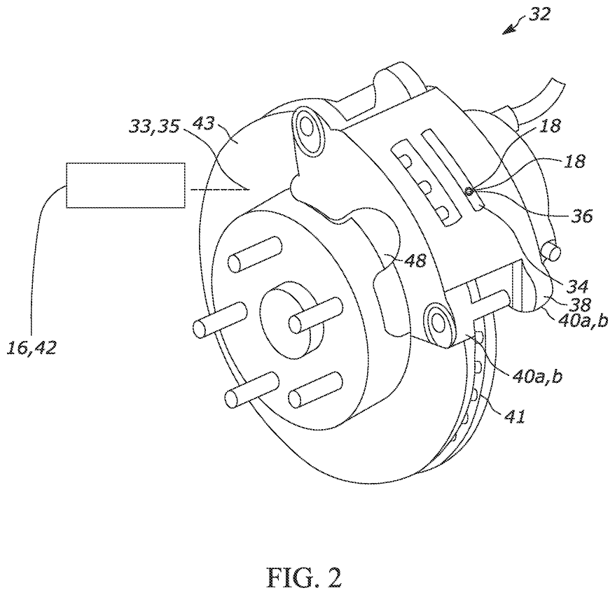

In one example embodiment, as illustrated in FIG. 1, the braking system 10 comprises sensor inputs 12a, 12b, 12c, 12d, 12e, and 12f which are located on a vehicle 11 or trailer 13 and paired to corresponding brakes 14a, 14b, 14c, 14d, 14e, and 14f by corresponding sensors 16. In an illustrated example embodiment of FIG. 2, the sensors 16 are temperature sensors 18 such as thermocouples. In another example embodiment, the thermocouples 18 utilized are k-type thermocouples. In yet another example embodiment, the sensors 16 are infrared sensors 42. The sensors 16 are in direct communication with a trailer electronic control unit (ECU) 20, which is in communication with a temperature display 22 in a vehicle 11 such as a truck cab. One of ordinary skill in the art would understand that the trailer 13 may have a second trailer ECU 30 which comprises a communication box 21 and corresponds with a second set of brakes. The vehicle or truck 11 also features its own inputs 24a, 24b, 24c, and 24d which are paired to corresponding brakes 26a, 26b, 26c, and 26d and feature temperature sensors 28. These temperature sensors 28 are in direct communication with a truck electronic control unit (ECU) 30, which is also in communication with the temperature display 22 of the truck cab.

The brake system 10's first and second temperature sensors 16, 28, respectively, monitor temperature at the brakes 14a-f and 26a-d of a vehicle 11 comprising a truck and/or trailer. Early warning of brake temperature overheating or underheating may advantageously prevent users from unexpected vehicle failure. Temperature sensing of the sensors 16, 28 may be performed by infrared sensors, thermocouples, RTDs, NTCs, PTCs, semiconductor devices, or an equivalent sensor, as would be understood by a person of ordinary skill in the art. In one example embodiment of the present disclosure, the sensors 16, 28, which comprise thermocouples 18, generate voltage throughout their electrical circuit, which translates into a temperature reading of a brake (for example, 32) itself. In another example embodiment, the sensors 16, 28, comprise infrared sensors 42, which target a specific location on the corresponding brake and measure infrared energy to a corresponding voltage, which converts to a temperature reading.

The use of a thermocouple 18 as a temperature sensor 16, 28 is advantageous for purposes of the present disclosure because it can be used in a cost-efficient way. In one example embodiment, a k-type thermocouple 18 is used to provide increased accuracy of the temperature reading. In another example embodiment of the present disclosure, weather-resistant wire or cable may also be used, which still provides cost efficiency over traditional thermocouple weather-resistant wire. A mixed wire system of telephone wire or equivalent and weather-resistant wire may also be used in accordance with the present disclosure. The type of thermocouple 18 used determines the degree of accuracy of the temperature reading, depending on the needs of the user. If the user needs accuracy that is to the degree, a mixed wire system of telephone wire and weather resistant wire may be used. If the user needs accuracy to the tenth of the degree, a k-type thermocouple may better suit the user's needs. The braking system 10 offers flexibility and is compatible with a variety of types of wires that may accommodate a variety of user needs.

The temperature sensors 18 may be coupled to the brakes 14a-f, 24a-d of the trailer 13 and/or truck 23 at a variety of locations, which depends on the type of brake being paired with the thermocouple 18. In the illustrated example embodiment, there are six temperature sensors 18 on a vehicle trailer 13, one for each set of tires, while there are four temperature sensors 18 hardwired to a truck cab 23's axles. The temperature sensors 18 or sensor 16 may be coupled to a brake in any area of the brake that accurately represents the heat of the brake. In FIGS. 2 and 9, the thermocouple 18 is engaged with a disk brake 32. The disk brake 32 features a brake lining 34 having an embedding surface 36 wherein the sensor 16 may be implanted. The implantation may occur at various depths of the brake lining. In one example embodiment of the present disclosure, implantation of the sensor 16 occurs at a ⅜ of an inch depth into the brake lining 34. In another example embodiment, the temperature sensor 16 is approximately ⅛ of one inch to 1 and ½ inches from the heat source being measured, such as, the brake pad 48, brake lining 34, brake shoe 52, and any combination thereof and the like.

In yet another example embodiment, the embedding surface 36 comprises an inspection hole through which the temperature sensor 18 is mounted. In another example embodiment, the embedding surface 36 is drilled or tapped at a certain depth into the brake lining 34, and the thermocouple 18 is mechanically fastened to the lining 34. In yet another example embodiment, the sensor 16 is a temperature sensor 18 is embedded on an embedding surface 38 in the inner or outer brake pad 40a, 40b, and the embedding surface 38 in this embodiment may also comprise an inspection hold through which the thermocouple 18 may be wired, or mechanically fastened to the embedding surface 36 which is drilled or tapped to a certain depth.

In another example embodiment, the sensor 16 is an infrared sensor 42 which is aimed at the rotor 41 or inner or outer brake pad 40a, 40b. In yet another example embodiment, the target of the sensor may be aimed at the disk 43 or shoe 52 of the brake 32. The sensor 16, in another example embodiment, may be aimed at any area of the brake 32 that collects heat and is representative of the temperature of the brake 32.

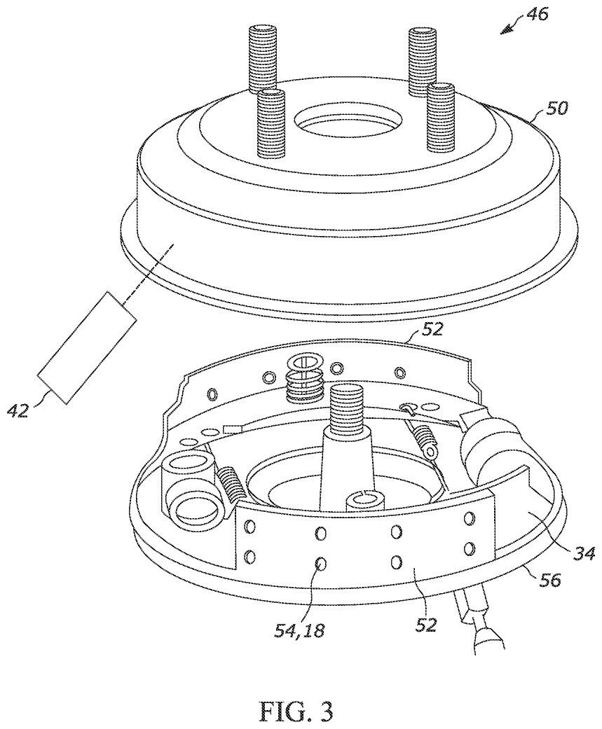

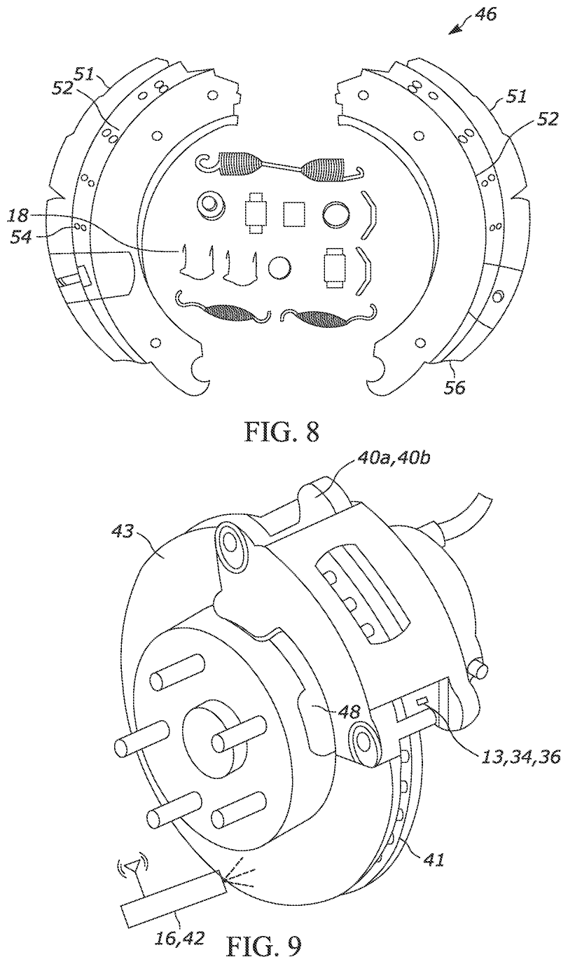

FIGS. 3 and 8 illustrate a sensor engaged with a hydraulic drum brake 46 in accordance with another example embodiment of the present disclosure. In this example embodiment, the target of the sensor 16 is aimed at the pad 48, drum 50, shoe 52, or any other area of the brake 46 that collects heat and is representative of the temperature of the brake 46. If a thermocouple 18 is used as opposed to an infrared sensor 42, the thermocouple may pass through an opening 54 of a backing plate 56 of the drum brake 46 and be embedded, attached, or otherwise coupled at the brake pad 48, lining 34, or shoe 52, or any other component of the brake system 10 that is representative of the heat of the brakes. As with the disk brake 32, the sensor may be inserted and/or coupled at various depths in the pad 48, drum 50, or shoe 52. In one example embodiment of the present disclosure, implantation of the sensor 16 occurs at a ⅜ of an inch depth into the brake lining. In another example embodiment, the sensor 16 is coupled to the drum brake 46 at a depth of ½ of an inch into the pad 48, drum 50, or shoe 52. In another example embodiment, the temperature sensor 16 is approximately ⅛ of one inch to 1 and ½ inches from the heat source being measured, such as, the brake pad 48, brake lining 34, brake shoe 52, brake drum 50, and any combination thereof and the like.

A wire 59 may directly connect the sensor 16, 28 to the display 22 in the cab of the vehicle for sensed temperature display, or the sensor 16, 28 may connect to a processor 44, and sensed temperature information may be wired 59 or wirelessly communicated to the display 22 by a transceiver 49 coupled to the ECUs 20, 30, processor 44, and/or display 22, as described above. In another example embodiment, the sensors 16, 28, comprise infrared sensors 42, which target a specific location on the corresponding brake and measure infrared energy, which converts in the processor 44 of the ECU 20, 30 to a temperature reading.

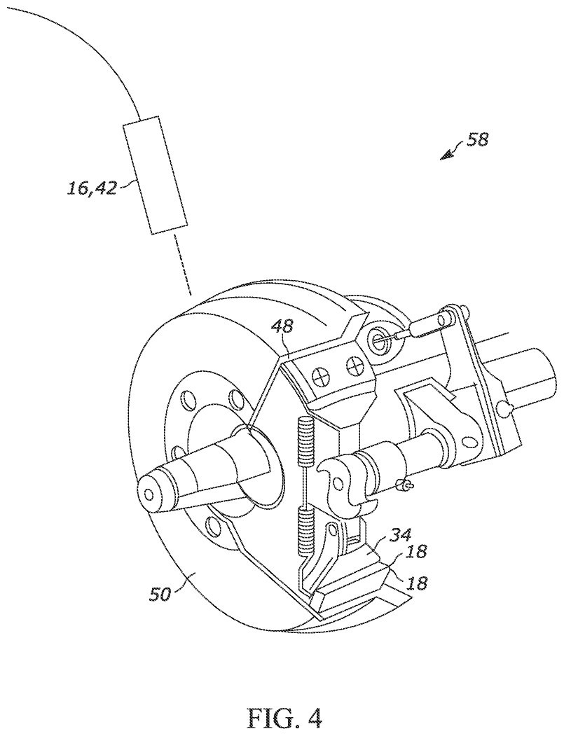

FIG. 4 exemplifies the use of the temperature sensor 16, 28 with an air brake system 58. In this example embodiment, the target of the sensors 16, 28 is aimed at the lining 34 or shoe 52, or any other area of the brake that collects heat and is representative of the temperature of the brake. If a thermocouple 18 is used as opposed to an infrared sensor 42, the thermocouple may be embedded or attached at the brake pad 48 or shoe 52, or any other component of the brake system that is representative of the heat of the brakes. A wire 59 having first and second ends 59a, 59b may directly connect the sensor 16, 28 to the display 22 in the cab of the vehicle for sensed temperature display, or the sensor 16, 28 may connect to a processor 44, and sensed temperature information may be wirelessly communicated to the display 22, as described above. In another example embodiment, the sensors 16, 28, comprise infrared sensors 42, which target a specific location on the corresponding brake and measure infrared energy, which is converted from a power signal 17 (such as DC voltage) to a corresponding temperature by the processor 44 to a temperature reading. As with the disk brake 32 and drum brake 46, the sensor 16 may be implanted or coupled at a variety of depths into the target of the sensors 16, 28. In one example embodiment, the sensor 16, 28 is coupled to the air brake 58 lining 34 or shoe 52 at a depth of ⅜ of an inch. In another example embodiment, the sensor 16, 28 is coupled to the air brake 58 lining 34 or shoe 52 at a depth of ½ of an inch. In another example embodiment, the temperature sensor 16 is approximately ⅛ of one inch to 1 and ½ inches from the heat source being measured, such as, the brake pad 48, brake lining 34, brake shoe 52, and any combination thereof and the like.

As illustrated in FIGS. 1 and 2, communication of the chosen sensor or sensors 16, 28 may be transmitted to a display 22 in a cab of a vehicle in a variety of ways. Sensors 16, 28 may be hard wired 59 to a processor 44. In one example embodiment, electronic control units 20, 30, located adjacent to brake sets in the trailer 13 and truck 23, respectively, wirelessly transmit 49 temperature information to the display 22. Alternatively, the sensors 16, 28 transmit a power signal 17 to inputs/outputs (I/O) 19 in the ECUs 20, 30, where the processor 44 converts the power signal 17 into corresponding temperature signal/value 21 that is shown on the display 22. Data from the electronic control units 20, 30 may be transmitted to the display 22 wirelessly 49 via through short-wave radio waves (Bluetooth), controller area network (CAN bus), and/or corded communication from the ECU 20 and/or 30. A wire 59 may directly connect the sensor 16, 28 to the display 22 in the cab of the vehicle for sensed temperature display, or the sensor 16, 28 may connect to the processor 44 in a display 22, and sensed temperature information may be wirelessly 49 communicated to the display 22, as described above.

Information from the temperature readings collected by the sensors 16, 28 may be stored via axle set data collection 43 (such as a database 45), which may allow for automatic “axle group” identification. In one example embodiment of the present disclosure, a lookup table is utilized to store sets of data that may be used to quickly identify temperature ranges that warrant a notification. The data 43 may be logged and stored through system memory 71. A log of the data 43 may be downloaded remotely via laptop, smart phone, tablet, or on an equivalent device 51.

This feature is useful because historical records may reveal patterns in brake overheating or underheating that signify a lack of adjustment in the brake system 10 and exactly which brakes on the truck or vehicle 11 are affected. Advantageously, this provides cost reduction for brake system 10 users because such monitoring may extend the life of brake lining 34 used with the brakes. The monitoring and recording features of the data 43 of the present disclosure may also provide business advantages to users because these features may reveal a pattern of vehicle abuse that signify a risk of increased maintenance costs for the business. A record of wear-and-tear data 43 may become a predictive tool for business owners of necessary maintenance intervals, thus aiding in timely maintenance scheduling.

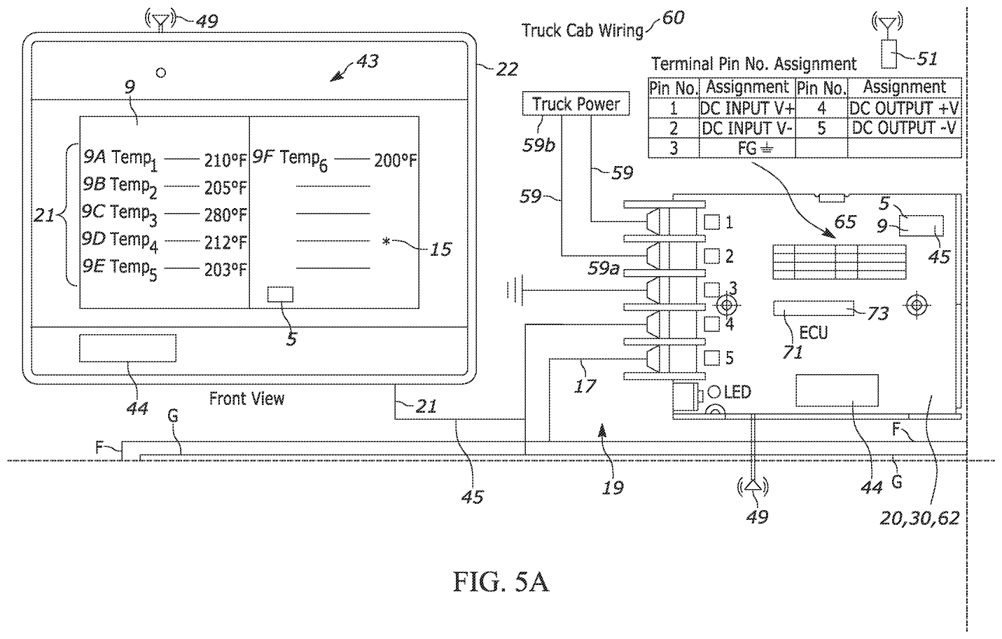

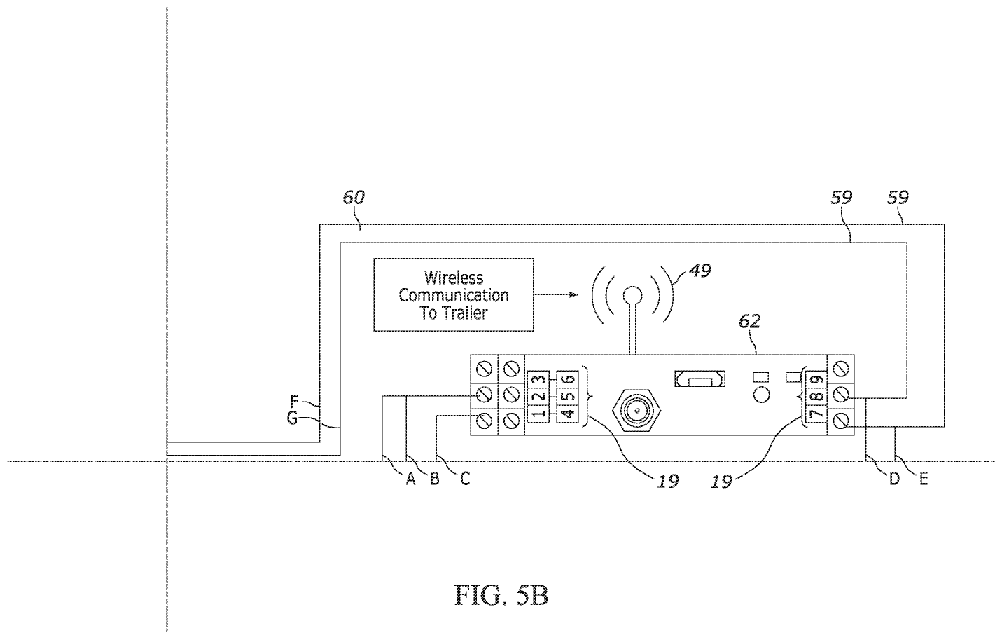

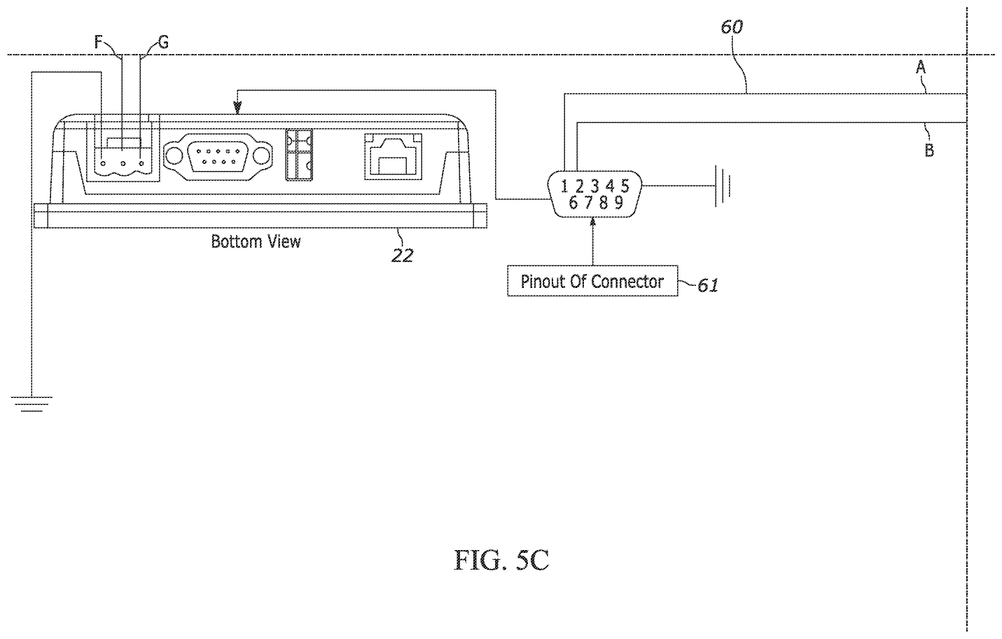

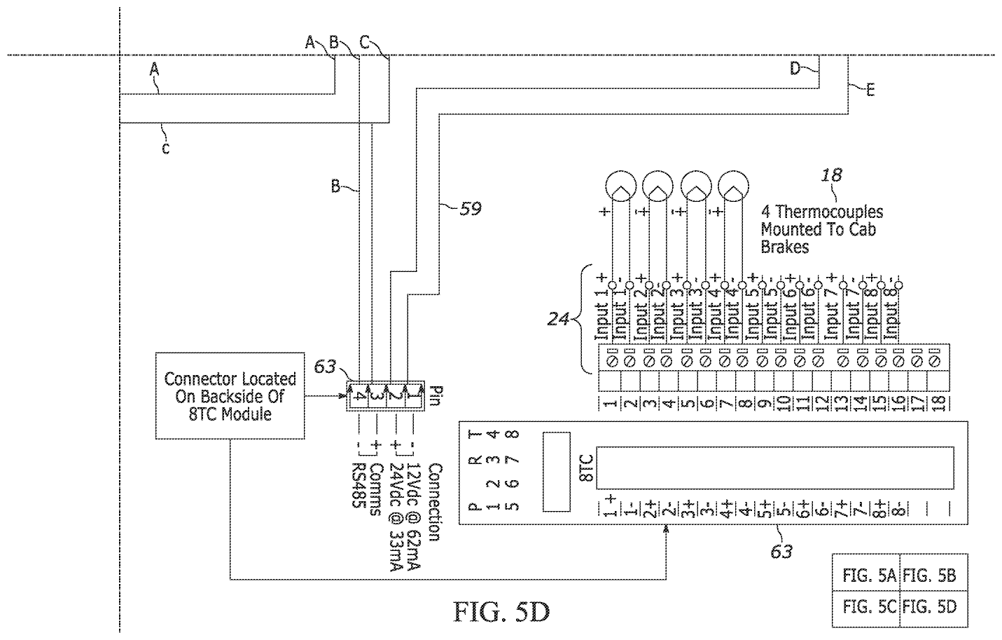

FIGS. 5A-5D show truck cab 23 wiring 60 for the brake system 10. The truck cab 23 wiring 60 is provided with the above-mentioned sensor 28, which, in this embodiment, comprises thermocouples 18. In this example embodiment, the thermocouples 18 are k-type thermocouples having a part number of LT-104 manufactured by Twidec, however, one of ordinary skill in the art would recognize that alternative thermocouple 18 types may be used. The present disclosure utilizes a plurality of thermocouples 18. In one example embodiment, four thermocouples 18 are used. One of ordinary skill in the art would recognize that more or fewer thermocouples 18 may be used.

The truck cab wiring 60 further comprises a connector 61 which couples the thermocouples 18. In one example, the thermocouple wire is Type 24 AWG Thermocouple Wire manufactured by Meter Depot, having a part number of X002E1D8ZX. The thermocouples 18 are coupled to an input module 63 and a voltage isolator 65 for individualized transmission of the temperature power readings. In one example embodiment, the input module 63 is an 8-channel thermocouple input module manufactured by Brainchild and having a part number of IO-BTC, and the voltage isolator is a 12 VDC voltage isolator manufactured by Mean Well and having a part number of SD-15A-12. One of ordinary skill in the art would understand that a variety of input modules 63 and voltage isolators 65 may be used in compatibility with the present disclosure.

As shown in FIG. 5B, hard wiring 60 extends from the thermocouples 18 and brakes to the truck ECU 30, which, in the present disclosure, may also comprise wireless communication 49. In one example embodiment, the truck ECU 30 comprises a transceiver 49, 62 and processor 44. Multiple transceivers 49, 62 may be used with the present disclosure, with one located in or on a trailer 13 and one in a truck 23, and both communicating with a centralized processor 44 and/or display 22. The transceiver 62 may detect transmissions from the thermocouples 18 and transmit them to a processor 44 and display 22. In one example embodiment, the transceiver 62 is an AIRGATE MODBUS wireless RS-485 Gateway manufactured by Novus with a part number of 8816041310. One of ordinary skill in the art would understand that multiple types of transceivers 49, 62 would be compatible with the brake system 10 of the present disclosure. The transceiver 62 allows for wireless communication between the vehicle trailer 13 and vehicle cab 23 by communicating with any additional transceivers 62 and the processor 44. The transceiver 62 of the present disclosure allows for automatic wireless connection to the strongest signal received via Wi-Fi, Bluetooth, or any other wireless signal or protocol. If the disconnection occurs, automatic reconnection will ensure the trailer 13 of the vehicle 11 is the trailer 13 in communication with the transceiver 62.

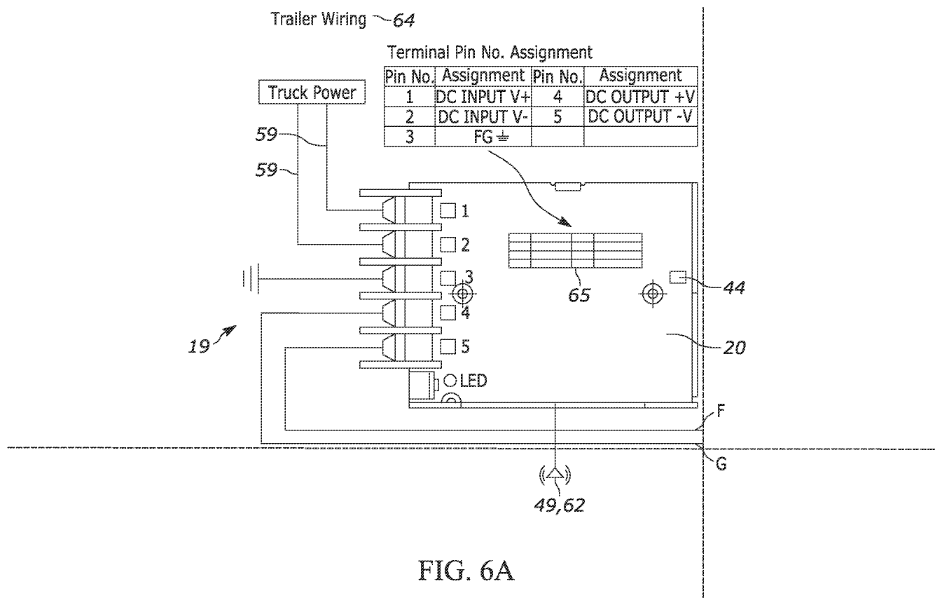

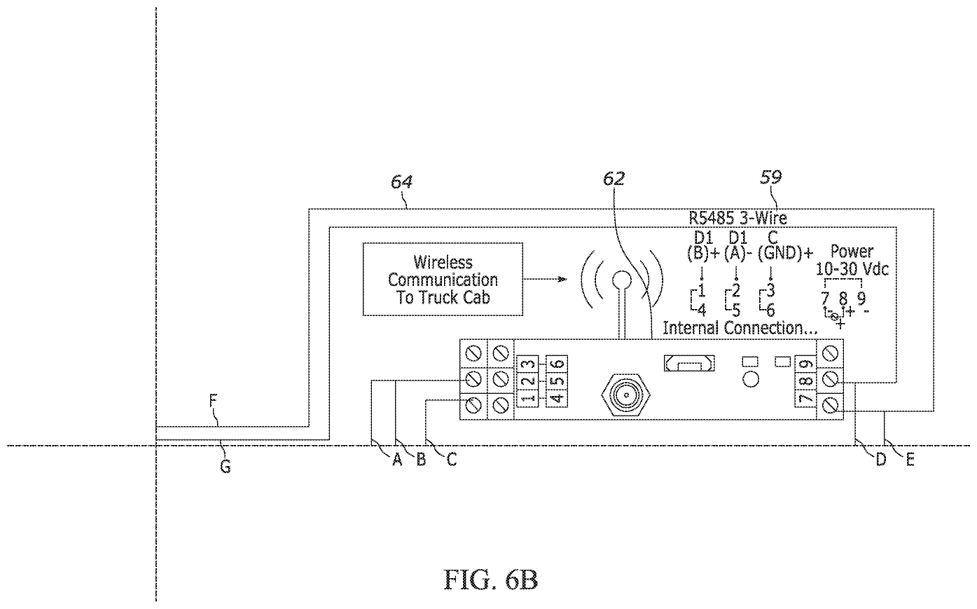

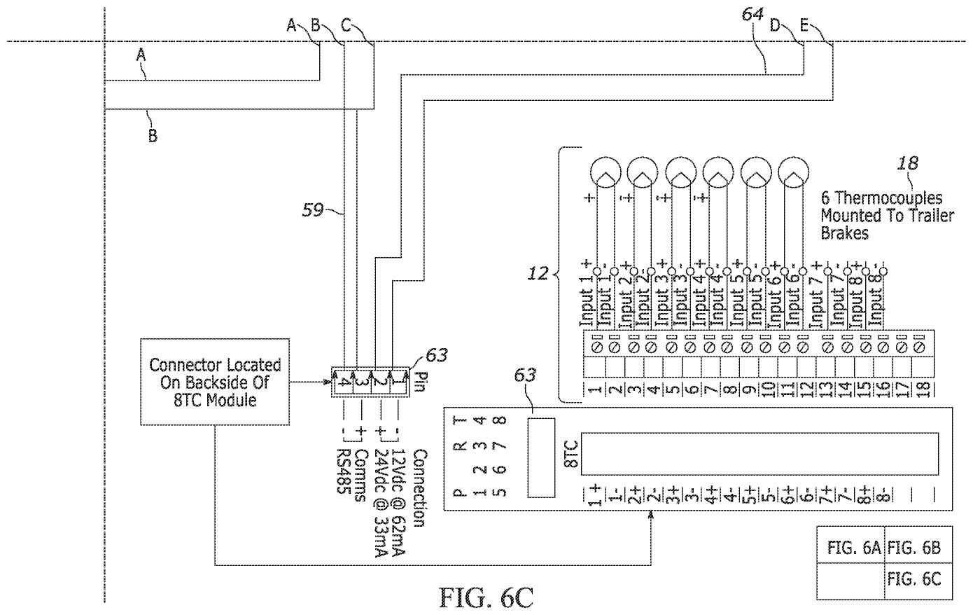

FIG. 5D shows an example embodiment of the present disclosure featuring inputs 24 paired with four thermocouples 18. In this example embodiment, the connector 61 is located on the back of an 8TC module 63. FIGS. 6A-6C show substantially similar wiring 64 for a trailer for communication to a processor 44 and display 22. The trailer wiring 64 similarly comprises a trailer ECU 20 which, in this example embodiment, comprises a transceiver 49, 62 and processor 44. The transceiver 49, 62 allows for wireless communication between the inputs 12a-f and thermocouples 18 to any additional transceivers 49, 62 and the processor 44 and truck display 22 either wired from the I/O 19, or wirelessly 49.

Based on a sensed temperature received by the thermocouples 18, the processor 44 may transmit a notification 15 to the display 22. Transmittal of a notification occurs when the brakes hit a temperature that is inside or outside of a threshold temperature 9 set by either a series of operations are performed by the processor 44 off an application specific analog circuit 47 within the ECU 20, 30, such as a comparator, amp lifter, digital signal processor or any combination thereof, the user, within the processor 44 and/or a look up table in the database 45 that is compared to the power signal 17. Alternatively, the threshold temperature 9 may be set by the manufacturer. The user or manufacturer may set a number of temperature points which will correspond with a notification 15. For example, a first set point may be a first temperature 9A, and the second set point may comprise a maximum set temperature 9B. In one example embodiment of the present disclosure, a notification is sent when brakes hit a temperature of 450 degrees Fahrenheit and above, with 450 degrees being the first set point. Third and fourth set temperatures 9C, 9D, 9E, 9F, and so on, may be assigned to specific brakes on a vehicle 11, for example, the trailer 13 brakes may be set to a different temperature threshold if the trailer 13 is loaded or unloaded. Left or right side brakes of the vehicle 11 may be set differently for the threshold temperature 9 based on a route that has a number of curves in one direction.

The notification 15 sent to the display 22 is visual in one embodiment of the present disclosure. In one example embodiment, the visual display 22 comprises a 4.3 in touchscreen LCD display 22 by Maple Systems, having a part number of HMI-5043LB. In another example embodiment, the notification 15 is auditory and is transmitted to a speaker (not shown). In yet another example embodiment, the notification 15 is both visual from the display 22 and auditory. One of ordinary skill in the art would understand, after reviewing this description and accompanying drawings, that a variety of notification methods are compatible with the present disclosure.

Additionally, the brake system 10 of the present disclosure may allow for multiple types of notifications 15 based on sensed brake temperature. As the brakes in the system 10 overheat, the display 22 may show different notifications 15 based on the level of danger presented by the sensed temperature. In one example embodiment, the notification 15 method is a color changing bar with indicators set to a range of received temperatures. The notification 15 method of this example embodiment relies on presentation of a set color on the display 22 to indicate the received temperature in question. For example, the visual display 22 may show a green light and/or temperature when received temperature is below a first set point, or threshold 9A, a yellow light when the received temperature is past a first set point but below a second set point, or threshold 9B, and a red light when the received temperature is above a second set point, or threshold 9C.

The processor 44 may rely on a lookup table 45 to compare the received temperature 17 with a set of predetermined values and base transmission of a notification 15 on said table. The processor 44 also comprises memory 71 that may store brake temperature for each brake in a vehicle 11, which reveals patterns and can alert 15 the user of a need for maintenance of brakes.

Temperature of brakes received via power signal 17 by the processor 44 is stored in system memory 71 to create a log 73 of brake temperatures. In one example embodiment, the brake system 10 is programmed to log the temperature every 5 seconds in the database 45. In another example embodiment, the brake system 10 is programmed to log the temperature every 10 seconds in the database 45. A variety of intervals for temperature logging may be used in connection with the present disclosure, where the data 9 can be viewed through the display 22 or downloaded to a remote device 51. The system 10 is also set to keep the last set data point 15 upon restart of the vehicle 11, to avoid the problem of the user needing to aid in brake system 10 setup upon each restart of the vehicle 11.

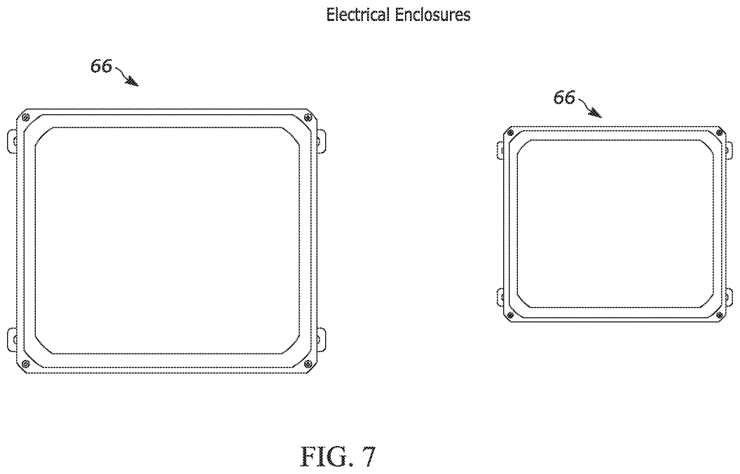

FIG. 7 shows electrical enclosures 66 that may be used to enclose the wiring 60, 64, and ECU 20, 30, of the brake system 10. In one example embodiment of the present disclosure, the electrical enclosure 66 comprises an approximately 13 by 11 by 6 inch electrical box manufactured by Poly Case. In another example embodiment, the electrical enclosure 66 comprises a 17 by 15 by 9 inch electrical box manufactured by Poly Case. One of ordinary skill in the art, after reviewing this description and associated drawings, would understand that a variety of sizes of electrical enclosures 66 may be compatible with the present disclosure.

Operation of the brake system 10 will now be described.

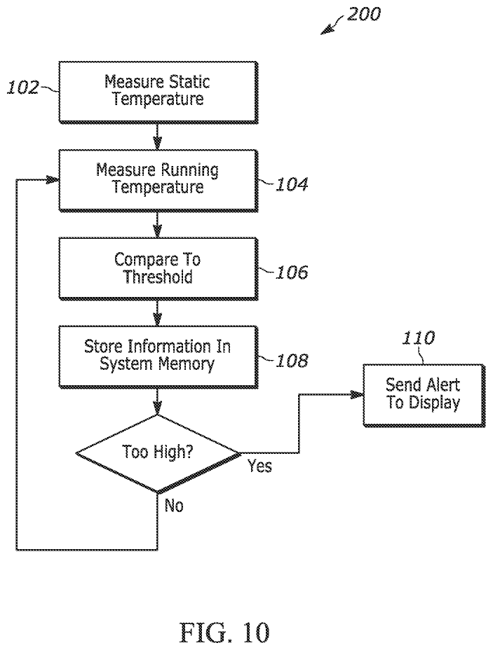

In FIG. 10, a method of operation 100 of a brake system 10 is shown. The brake system 10 utilizes the features described in the above description and claims with the associated figures. The method of operation 100 allows real time readings of brake temperature to be delivered to a display 22 and electronic control unit 20, 30 of a vehicle 11. At step 102 of the method of operation, a baseline or static temperature 33 of a set of brakes is measured by a sensor 16. At step 104, the sensor 16 measures a running temperature 35 of the same set of brakes. At step 106, the sensor 16 compares the measured temperature 35 to the baseline or static temperature 33. At step 108, the processor 44 stores 45 the measured temperature 35 in its system memory 71. If the measured temperature 35 exceeds the baseline temperature 33 by a pre-set threshold amount 9, at step 110, a notification is sent to the display and electronic control unit of the truck. As discussed above, the notification may be visual, auditory, or a combination of both. If the measured temperature does not exceed the baseline temperature by the threshold amount, the method of operation returns to step 104 and performs the method again while storing each temperature value received in memory 71.

In the foregoing specification, specific embodiments have been described. However, one of ordinary skill in the art appreciates that various modifications and changes can be made without departing from the scope of the disclosure as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. In one non-limiting embodiment the terms are defined to be within for example 10%, in another possible embodiment within 5%, in another possible embodiment within 1%, and in another possible embodiment within 0.5%.

The term “coupled” as used herein is defined as connected or in contact either temporarily or permanently, although not necessarily directly and not necessarily mechanically. A device or structure that is “configured” in a certain way is configured in at least that way but may also be configured in ways that are not listed. The term “integral” as used herein unless defined otherwise means configured in such a way that separation would require destruction to the parts or the assembly of the parts.

It should be appreciated by those of ordinary skill in the art after having the opportunity of reviewing the drawings and/or specification of the present disclosure that it may include one or more embodiments, e.g., E₁, E₂, . . . Eₙ and that each embodiment E may have multiple parts A₁, B₁, C₁ . . . . Zₙ that (without further description) could be combined with other embodiments Eₙ, embodiment parts e.g. A₁, C₁, or lack of parts originally associated with one or all embodiments Eₙ, or any combination of parts and/or embodiments thereof. It should further be appreciated that an embodiment Eₙ may include only one part e.g. A₁ or a lesser number of parts e.g. B₁, C₁ of any embodiment or combination of embodiments that was described or shown in the specification and/or drawings, respectively in ways not enumerated or illustrated.

To the extent that the materials for any of the foregoing embodiments or components thereof are not specified, it is to be appreciated that suitable materials would be known by one of ordinary skill in the art for the intended purposes after having the benefit of reviewing the subject disclosure and accompanying drawings.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A brake monitoring apparatus for a vehicle comprising:
a plurality of temperature sensors configured to measure the temperature of each of a plurality of brakes located on a vehicle during use, wherein each sensor has a corresponding wire;
the wire having first and second ends;
the first end of the wire for communicative coupling to one of the plurality of temperature sensors, the second end being communicatively coupled to an electronic unit;
the electronic control unit comprising a processor and memory, the electronic control unit being communicatively coupled to a visual display, wherein the plurality of temperature sensors send power signals to the electronic control unit which converts and sends temperature values of any one of the plurality of brakes for viewing during operation on said visual display;
further wherein said plurality of temperature sensors send power signals to said electronic control unit where said electronic control unit converts said power signals with said processor or an application specific analog circuit to a respective temperature value for each brake;
yet further wherein each temperature value for each brake is compared in the electronic control unit comprising a database with a selective threshold temperature assigned to each brake such that when one or more temperature values exceed said threshold temperature, a notice is transmitted to said display indicating the brake and that the temperature threshold that has been exceeded.

2. The brake monitoring apparatus of claim 1, wherein the temperature threshold range is 450 degrees F.-900 degrees F.

3. The brake monitoring apparatus of claim 1, wherein the temperature sensor comprises a thermocouple.

4. The brake monitoring apparatus of claim 3, wherein the brakes comprise drum brakes and wherein the thermocouple is coupled to a backing plate of a brake shoe of any one of the plurality of drum brakes.

5. The brake monitoring apparatus of claim 4, wherein the thermocouple is coupled to the brake shoe of any of the plurality of drum brakes at a depth of ⅜ of an inch into said brake shoe.

6. The brake monitoring apparatus of claim 3, wherein the thermocouple comprises a K-type thermocouple.

7. The brake monitoring apparatus of claim 3, wherein the brakes comprise disk brakes and wherein the thermocouple is coupled to a brake lining at a depth of ⅜ of an inch into said disk brake.

8. The brake monitoring apparatus of claim 3, wherein the brakes comprise air brakes and wherein the thermocouple is coupled to a brake shoe at a depth of ⅜ of an inch into said air brake.

9. The brake system of claim 1, wherein the temperature sensor comprises an infrared sensor.

10. A method of temperature monitoring for a brake system comprising the steps of:
assigning a temperature range as a target temperature range on a brake monitoring system; the brake monitoring system comprising a plurality of brakes a plurality of temperature sensors configured to measure the temperature of each of the plurality of brakes, wherein each sensor has a corresponding wire, the wire having first and second ends, the first end of the wire being coupled to the sensor, the second end being coupled to an electronic control unit comprising a processor and memory, the processor being coupled to a visual display;
identifying the temperature sensor input as a received temperature based upon the temperature sensor input responsive to receiving a temperature sensor input to the brake monitoring system;
matching the received temperature to the target temperature range;
generating a first signal responsive to matching the target temperature range to the received temperature; and
generating a second signal responsive to exceeding the target temperature range to the received temperature.

11. The method of operating a brake system of claim 10, wherein the target temperature range is 450 degrees F.-900 degrees F.

12. The method of operating a brake system of claim 10, further comprising the step of:
projecting an audio notification.

13. The method of operating a brake system of claim 10, further comprising the step of:
displaying a visual notification.

14. The method of operating a brake system of claim 10 further comprising the step of:
responsive to failing to match the target temperature range to the received temperature, measuring a received temperature after a predetermined passage of time.

15. The method of operating a brake system of claim 10 further comprising the step of:
storing the received temperature in system memory.

16. A brake monitoring system for a vehicle comprising:
a plurality of brakes;
a vehicle electronic control unit comprising a processor having memory;
a vehicle visual display; and
a plurality of thermocouples configured to measure the temperature of each of the plurality of brakes, wherein each thermocouple comprises a wire having first and second ends, the first end of the thermocouple wire being communicatively coupled to one of the plurality of brakes on an embedding surface of said brakes, the second end communicatively coupled to said vehicle electronic control unit, wherein each thermocouple receives a measured temperature of a corresponding one of said plurality of brakes and transmits said measured temperature through the thermocouple to the vehicle electronic control unit, wherein the electronic control unit allows for a selectively programmable temperature threshold for the received temperature from any one of the plurality of brakes and plurality of thermocouples, wherein the truck electronic control unit communicates said measured temperature to the vehicle visual display, and wherein a notification is transmitted from said vehicle visual display and wherein said notification is triggered when said measured temperature is at or above the selectively programmed threshold.

17. The brake monitoring system of claim 16, wherein the brake monitoring system further comprises a trailer electronic control unit comprising a processor having memory, and wherein said truck visual display receives a trailer brake temperature from the trailer electronic control unit and communicates said temperature to said truck visual display.

18. The brake monitoring system of claim 16, wherein the thermocouple is coupled to the brake shoe of any of the plurality of drum brakes at a depth of ⅜ of an inch into said brake shoe.

19. The brake monitoring system of claim 16, wherein the brakes comprise disk brakes and wherein the thermocouple is coupled to a brake lining at a depth of ⅜ of an inch into said disk brake.

20. The brake monitoring system of claim 16, wherein the brakes comprise air brakes and wherein the thermocouple is coupled to a brake shoe at a depth of ⅜ of an inch into said brake shoe.
